(19) United States
(12) Patent Application Publication
(10) Pub. No.: US 2013/0137525 A1
(43) Pub. Date: May 30, 2013

(54) GEAR MECHANISM

(71) Applicant: Shanghai Kohler Electonics, Ltd., Shanghai (CN)

(72) Inventors: Xiaojun Zhou, Shanghai (CN); Yihua Wang, Shanghai (CN)

(73) Assignee: Shanghai Kohler Electonics, Ltd., Shanghai (CN)

(21) Appl. No.: 13/683,961

(22) Filed: Nov. 21, 2012

(30) Foreign Application Priority Data
Nov. 22, 2011 (CN) 201120469071.8

(51) Int. Cl. F16D 7/00

(52) U.S. Cl. CPC F16D 7/00
USPC 464/39

(57) ABSTRACT

An overload protection transmission device is shown and described. The overload protection transmission device includes a main transmission having a cone-shaped side and a toothed-edge part, the main transmission defining a cavity a drive shaft fitted within the main transmission, a frustum located on the corresponding side of the drive shaft to the cone-shaped side of the main transmission, a cavity sealing part formed to create a seal between the toothed-edge part and the drive shaft, and a compressed spring part inside the cavity. Due to the design of the compressed spring part inside the main transmission and the drive shaft, adjustment to the spring load of the spring part may advantageously be used to regulate the maximum gear load (e.g., in accordance with load changes and requirements).

### CROSS-REFERENCE TO RELATED PATENT APPLICATIONS

This application claims the benefit of and priority to China Utility Model Appl. No. 201120469071.8, filed Nov. 22, 2011, the entirety of which is incorporated herein by reference.

### FIELD

The present disclosure relates to the field of transmissions and more particularly relates to a type of an overload protection transmission device.

### BACKGROUND

Gears are structured and used to join a power device to a load device. With reference to the representative prior art illustration of FIG. 1, a conventional power device transmits power to gear 1′ by means of gear shaft 2′, then gear 1′ transmits power to the load device. However, sometimes due to overload, the gear 1′ is unable to power the load device. If there is no overload protection device installation, this can result in damage to the gear 1′ or create further damage to the power device.

The technical proposals of some existing gear overload protection devices, e.g., such as China published invention Patent Application No. 101956800A, provide a type of gear overload protection device. Such a conventional overload protection device includes a drive shaft, spring part and separable part. The drive shaft includes a joining section. The separable part includes a rotary shaft recess, and said spring part joins to the rotary shaft recess of the separable part and covers the circumferential surface of the drive shaft joining section. The drive shaft is joined to the separable part by said spring and when the load of the load device is lower than a given value, said drive shaft and separable part rotate synchronously. When the load of the device is greater than a given value, the spring is propelled or impeded by said drive shaft to create a change in the spring structure and thereby creating a corresponding rotation of said drive shaft and said separable part. In other words, the above described existing technical proposal uses a change in the spring structure to realize a separable joint between the power device and load device used to protect the gear and power device. However, this solution is limited in that its given load value is determined once the spring structure is determined, and the device cannot automatically adjust the given load value and therefore the maximum transmitted load.

### SUMMARY

One object of the present disclosure is to provide a type of overload protection transmission device that, at the same time as giving overload protection, also adjustably regulates the maximum load according to, e.g., load changes.

One embodiment of the present disclosure relates to an overload protection transmission device. The overload protection transmission device includes a main transmission having a cone-shaped side and a toothed-edge part, the main transmission defining a cavity. The overload protection transmission device further includes a drive shaft fitted within the main transmission and a frustum located on the corresponding side of the drive shaft to the cone-shaped side of the main transmission. The overload protection transmission device further includes a cavity sealing part formed to create a seal between the toothed-edge part and the drive shaft. The overload protection transmission device further includes a compressed spring part inside the cavity.

Another embodiment of the present disclosure relates to an overload protection transmission device. The overload protection transmission device includes a gear having a first surface, a drive shaft having a second surface configured to engage the first surface of the gear, a plate coupled to one of the drive shaft and the gear. The overload protection transmission device further includes a spring part coupled to the plate and providing a force to press the first surface and second surface into engagement when the load between the gear and the drive shaft is below a predetermined load.

Another embodiment of the present disclosure provides a type of overload protection transmission device including a main transmission and a drive shaft fitted within the described main transmission that has special characteristics in that there is a cone-shaped side and a toothed-edge part on the inside matching surfaces of the described main transmission and the described drive shaft. Located on the corresponding side of the drive shaft to the cone-shaped side is a frustum. A hollow cavity sealing part is formed to create a seal between the described toothed-edge part and the described drive shaft. There is a compressed spring part inside the described hollow cavity.

According to varying embodiments of the disclosure, the small radius end of the described frustum is close to the described spring part, the described seal part and described drive shaft are fixed together by a fixture, and there is a corresponding clearance between the described seal part and the described toothed-edge part.

According to varying embodiments of the disclosure, the seal part contains a thin threaded annular plate, and there are corresponding external threads on the described fixture part.

According to varying embodiments of the disclosure, the length of the described external threads is greater than the length of the described internal threads.

According to varying embodiments of the disclosure, the described toothed-edge part is formed by a vertical side and a horizontal side, a contact section is on the vertical side of the described spring part, and the other side of the spring part contacts the described seal part.

According to varying embodiments of the disclosure, the large radius end of the described frustum is close to the described spring part, the described seal part and described toothed-edge part are fixed together, and there is a corresponding clearance between the described spring part and the described drive shaft.

According to varying embodiments of the disclosure, the seal part has an annular plate with external threads, and the described toothed-edge part has internal threads that correspond to the described external threads.

According to varying embodiments of the disclosure, the length of the described internal threads is greater than the length of the described external threads.

According to varying embodiments of the disclosure, the described cone-shaped side has multiple evenly spaced and distributed depressions, and there are protruding teeth on the frustum side in the corresponding locations to the described depressions.

According to varying embodiments of the disclosure, the described cone-shaped side has multiple evenly spaced and distributed protruding teeth, and there are depressions on the frustum side in the corresponding locations to the described protruding teeth.

According to varying embodiments of the disclosure, the central axis of the described multiple depressions and protruding teeth intersect at the same point.

According to varying embodiments of the disclosure, the described spring part is a disc-shaped spring.

According to varying embodiments of the disclosure, there at least two of the described spring part.

According to varying embodiments of the disclosure, the described main transmission is a gear or a bearing.

According to varying embodiments, the objective of regulating the maximum load in accordance with adjusted load changes and requirements can be realized. This feature may be provided in part by the design of the compressed spring part in the hollow cavity between the main transmission and the drive shaft and by adjustment to the spring load of the spring part.

### BRIEF DESCRIPTION OF THE DRAWINGS

FIG. 1 is schematic diagram of a conventional joining method between the gear and gear shaft;

FIG. 2 is a front perspective view of an overload protection transmission device, according to an exemplary embodiment.

FIG. 3 is a rear perspective view of the overload protection transmission device of FIG. 2.

FIG. 4 is a cross-sectional view of the overload protection transmission device of FIG. 2.

FIG. 5 is an exploded view of the overload protection transmission device of FIG. 2.

FIG. 6 is a schematic diagram of an overload protection transmission device, according to another embodiment.

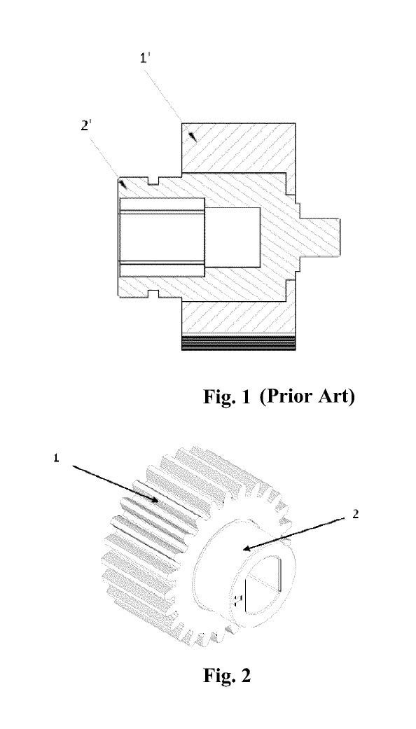

### DETAILED DESCRIPTION

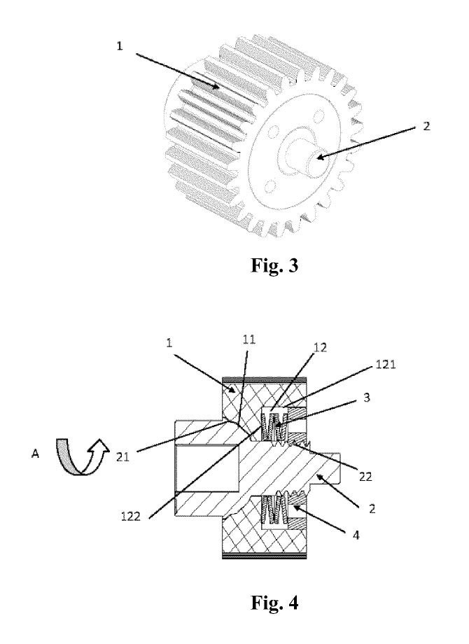

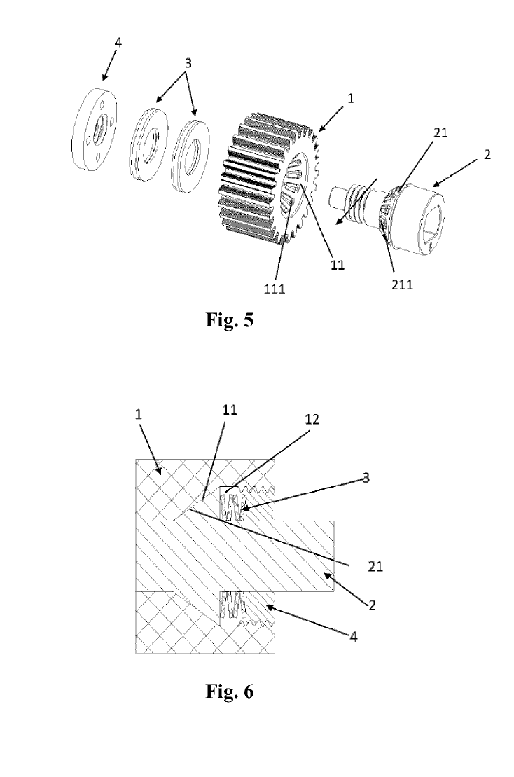

Referring to FIGS. 2-5, an exemplary embodiment of an overload protection transmission device is provided. As shown, the overload protection transmission device includes a gear 1 and a drive shaft 2 that is fitted within gear 1. The gear 1 includes a cone-shaped side 11 and a toothed-edge part 12 on the inside matching surfaces of the gear 1 and the drive shaft 2. A frustum 21 is located on the corresponding side of the drive shaft to the cone-shaped side 11. A hollow cavity sealing part 4 creates a seal between the toothed-edge part 12 and the drive shaft 2. A compressed spring part 3 is located inside the hollow cavity.

The mutual correspondence between the cone-shaped side 11 and the frustum 21 creates a certain frictional contact. In the present embodiment, multiple evenly spaced and distributed depressions 111 are on the cone-shaped side 11, and protruding teeth 211 are on the frustum 21 in corresponding locations to the depressions 111. In this way the protruding teeth 211 of the drive shaft 2 mutually contact with the depressions 111 on gear 1 to form a reliable interlocking structure. This type of interlocking structure is able to form a relatively greater friction that drives the gear 1 and the load rotation. This type of fixture can also be reversed, for example, with multiple evenly spaced and distributed protruding teeth on the cone-shaped side 11 and depressions on the frustum 21 in corresponding locations to the protruding teeth.

The small radius end of the frustum 21 is close to the spring part 3, and the seal part 4 is joined in place to the drive shaft 2 by the fixture 22. There is a corresponding clearance between the seal part 4 and the toothed-edge part 12. The toothed-edge part 12 is composed of a transverse wall, shown as vertical side 122, and an axial wall, shown as horizontal side 121. One end of the spring part 3 contacts the vertical side 122, and the other end of the spring part 3 contacts the seal part 4. The seal part 4 has a thin annular plate with internal threads, and there are external threads on the fixture 22 that correspond to the internal threads.

Operation of the exemplary embodiment of the overload protection device is described herein: As shown in FIG. 4, given the contact of one end of the spring part 3 to the vertical side 122 and the contact of the other end of the spring part 3 with the seal part 4, the spring part position is in a compressed state, respectively exerting opposite directional force on the vertical side 122 and the seal part 4. Furthermore given the joining of the seal part 4 and the drive shaft 2 by the fixture 22, the seal part 4 transmits force to the drive shaft 2. Thus the opposing force exerted on the gear 1 and drive shaft 2 ensures the close interlocking between the protruding teeth 211 and the depressions 111.

When the drive shaft 2 is subjected to a driving force in direction A, under normal load conditions, the drive shaft 2 drives the gear 1 and load rotation. Given that the drive shaft 2 and the gear 1 are correspondingly driven by means of the frustum 21 and the cone-shaped side 11, as well as the driving force in direction A exerted by the frustum 21 on the cone-shaped side 11, it also exerts a horizontal (i.e., axial) force on the drive shaft 2. When the load is gradually increased the pressure of the protruding teeth 211 of the drive shaft 2 on the gear 1 also gradually increases the horizontal force on the drive shaft 2. Once this force is great enough to overcome the spring load of the spring part 3, it has thus reached a maximum load and therefore forces the gear 1 away from the protruding teeth 211 of the drive shaft 2 and compresses the spring part 3. In this way, the protruding teeth 211 of the drive shaft 2 come apart from the depressions 111 of the gear 1, and the drive shaft 2 slips and rotates freely, no longer increasing the drive of the gear 1 and the load, realizing protection against overload.

According to the exemplary embodiment, the above described maximum load is regulated by means of adjusting the pre-fitted spring load. The seal part 4 can be fitted more deeply to lock the drive shaft 2 in place. The size of the hollow cavity after the seal has been compressed goes further to compress the spring part 3 from one end. Thereby, the spring load is increased from both ends, and therefore the drive shaft 2 can only overcome the spring load to open the gear 1 when the load is further increased. This type of spring load can be regulated further with deeper insertion of the seal part 4 and therefore is suited to an even wider range of applications.

In the present embodiment, the length of the external threads on the fixture 22 is greater than the length of the internal threads on the seal part 4. Thus the seal part 4 can be freely adjusted in the drive direction of the drive shaft 2 and the seal part 4 can be fixed in any location within the scope of the length of the external threads.

Further, the pre-fitted spring load can be adjusted to any value by means of regulating individual spring parts 3 and there can be two or more spring parts. The greater the amount of spring parts, the greater the spring force in the same space.

Further, the spring force can be regulated by selection of the spring part 3, and spring parts with varying spring coefficients can be chosen according to the requirements of the maximum load. The spring part can be a disc-shaped spring and the disc-shaped spring should be relatively thin and take up a small area to make it easier to fit inside the gear that is innately rather thin. The spring part can also be a normal spring or other type of spring component.

Further, the central line of the multiple depressions 111 and protruding teeth 211 should intersect at the same point.

According to varying alternative embodiments, the main transmission may not be a gear structure. Rather, for example, it can be a bearing or any other type of drive shaft and transmission driving force structure.

Referring to FIG. 6, an overload protection transmission device is shown, according to another embodiment. As shown, the large radius end of the frustum 21 is close to the spring part 3, the seal part 4 and toothed-edge part 12 are coupled (e.g., threaded, fixed, etc.) together, and there is a corresponding clearance between the seal part 4 and drive shaft 2.

What is claimed is:

1. An overload protection transmission device, comprising:
a main transmission having a cone-shaped side and a toothed-edge part, the main transmission defining a cavity;
a drive shaft fitted within the main transmission;
a frustum located on the corresponding side of the drive shaft to the cone-shaped side of the main transmission;
a cavity sealing part formed to create a seal between the toothed-edge part and the drive shaft; and
a compressed spring part inside the cavity.

2. The device of claim 1, wherein the frustum comprises a small radius end proximate the spring part, and wherein the seal part is coupled to the drive shaft.

3. The device of claim 2, wherein the seal part and the drive shaft are threadedly coupled.

4. The device of claim 3, wherein the seal part comprises internal threads, and the drive shaft comprises corresponding external threads.

5. The device of claim 3, wherein the driveshaft comprises threads having a first length, and the seal part comprises threads having a second length, and wherein the first length is greater than the second length.

6. The device of claim 2, wherein the toothed-edge part comprises a transverse wall and an axial sidewall, and wherein a first end of the spring part contacts the transverse wall and a second end of the spring part contacts the seal part.

7. The device of claim 1, wherein the frustum comprises a large radius end proximate the spring part, and wherein the seal part is coupled to the toothed-edge part.

8. The device of claim 7, wherein the seal part and the toothed-edge part are threadedly coupled.

9. The device of claim 8, wherein the seal part comprises external threads, and the toothed-edge part comprises internal threads that correspond to the external threads.

10. The device of claim 8, wherein the toothed-edge part comprise threads having a first length, and the seal part comprises threads having a second length, and wherein the first length is greater than the second length.

11. The device of claim 1, wherein the cone-shaped side comprises one or more depressions, and the frustum comprises one or more protruding teeth in locations corresponding to the depressions.

12. The device of claim 11, wherein a central axis of the one or more depressions and one or more protruding teeth intersect at a point.

13. The device of claim 1, wherein the cone-shaped side comprises one or more protruding teeth, and the frustum comprises one or more depressions in locations corresponding to the protruding teeth.

14. The device of claim 12, wherein a central axis of the one or more depressions and the one or more protruding teeth intersect at a point.

15. The device of claim 1, wherein the spring part is a disc-shaped spring.

16. The device of claim 1, wherein there at least two spring parts.

17. The device of claim 1, wherein the main transmission is a gear or a bearing.

18. An overload protection transmission device, comprising:
a gear having a first surface;
a drive shaft having a second surface configured to engage the first surface of the gear;
a plate coupled to one of the drive shaft and the gear; and
a spring part coupled to the plate and providing a force to press the first surface and second surface into engagement when the load between the gear and the drive shaft is below a predetermined load.

19. The device of claim 18, wherein the first surface and the second surface each substantially form at least a portion of a cone.

20. The device of claim 18, wherein the second surface comprises at least one protrusion, and the first surface comprises at least one depression configured to received the protrusion.
